(19) United States
(12) Patent Application Publication
(10) Pub. No.: US 2006/0039736 A1
(43) Pub. Date: Feb. 23, 2006

(54) Printing media feeding apparatus, printing apparatus provided with the feeding apparatus, printing media feeding speed control method and computer program

(75) Inventor: Kaoru Ogawa, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(73) Assignee: Sony Corporation

(21) Appl. No.: 11/203,395

(22) Filed: Aug. 12, 2005

(30) Foreign Application Priority Data
Aug. 23, 2004 (JP) P2004-242797

(51) Int. Cl. B41J 29/38

(52) U.S. Cl. 400/582

(57) ABSTRACT

The present invention has been made to prevent density irregularity from appearing in a print result and to thereby improve image quality by controlling a motor so that the rotational speed of a drive shaft that feeds printing media becomes constant. The present invention provides a printing media feeding apparatus including a feeding section that includes a motor, a drive transmission mechanism which transmits a driving force of the motor, and a drive shaft to which the driving force is transmitted by the drive transmission mechanism, the drive shaft being rotated to feed the printing media, a detection section that is provided in the drive shaft and detects the rotational speed of the drive shaft, and a controller that controls the motor, the controller controlling the motor based on an input from the detection section so that the rotational speed of the drive shaft becomes constant.

### CROSS REFERENCES TO RELATED APPLICATIONS

The present invention contains subject matter related to Japanese Patent Application JP 2004-242797 filed in Japanese Patent Office on Aug. 23, 2004, the entire contents of which being incorporated herein by reference.

### BACKGROUND OF THE INVENTION

1. Field of the Invention

The present invention relates to a printing media feeding apparatus, a printing apparatus provided with the feeding apparatus, a printing media feeding speed control method, and a computer program.

2. Description of the Related Art

In related art a thermal printer with a thermal head has a thermal head in which a plurality of heat elements are linearly arranged and controls power distribution to the heat elements depending on the tone level to heat a heat-sensitive recording layer, thereby printing an image on printing media.

In such a thermal printer, color density depends on the energy applied to the printing media. That is, to obtain deep color, the heating value of the heat elements is increased; to obtain light color, the heating value thereof is reduced.

The energy to be applied to the printing media is increased when the feeding speed of the printing media is low. In this case, the obtained color may become deeper than a desired level. On the other hand, the energy to be applied to the printing media is reduced when the feeding speed of the printing media is high, with the result that the obtained color may become lighter than a desired level.

As shown in FIG. 1, speed irregularity of the printing media appears as density irregularity in an image printed on the printing media, the density irregularity being formed by a plurality of lines running in the direction perpendicular to the feeding direction of the printing media. In FIG. 1, an area 101 is a low-density part, and area 102 is a high-density part. It is therefore demanded in the thermal printer that the speed irregularity in the feeding operation of the printing media be eliminated.

In general, the printing media feeding apparatus uses a stepping motor as a drive source to rotate a capstan of the final stage through a drive transmission mechanism such as a pulley, an endless belt, and a gear. The capstan feeds the printing media while holding the printing media together with a roller provided opposite thereto. Since a means for directly feeding the printing media is the capstan, the rotational speed of the capstan needs to be constant in order to feed the printing media at a constant speed.

However, it is difficult to make the rotational speed of the capstan constant, since it depends on the mechanical accuracy of the drive transmission mechanism. For example, the rotational speed of the capstan comes under the influence of the rotational accuracy of the pulley, the rotational accuracy of the capstan itself, and the like. However, even if the drive transmission mechanism has been mechanically assembled with high accuracy, it is still difficult to make the feeding speed of the printing media constant and eliminate the density irregularity.

As prior art documents related to a technique of eliminating the density irregularity, the following patent documents are known: Jpn. Pat. Appln. Laid-Open Publication Nos. H11-334160, H5-169708, 2001-239686, and S63-296976.

### SUMMARY OF THE INVENTION

The present invention has been made to solve the above problem, and it is desirable to provide a printing media feeding apparatus capable of controlling a motor so that the rotational speed of a drive shaft that allows the printing media to run become constant to prevent the density irregularity from appearing in the printing result to thereby increase image quality, a printing apparatus provided with the feeding apparatus, a printing media feeding speed control method, and a computer program.

According to the present invention, there is provided a printing media feeding apparatus comprising: a feeding means that includes a motor, a drive transmission mechanism which transmits a driving force of the motor, and a drive shaft to which the driving force is transmitted by the drive transmission mechanism, the drive shaft being rotated to feed the printing media; a detection means that is provided in the drive shaft and detects the rotational speed of the drive shaft; and a control means for controlling the motor, the control means controlling the motor based on an input from the detection means so that the rotational speed of the drive shaft becomes constant.

According to the present invention, there is provided a printing apparatus comprising: a print head that prints visual data on printing media; a feeding means that includes a motor, a drive transmission mechanism which transmits a driving force of the motor, and a drive shaft to which the driving force is transmitted by the drive transmission mechanism, the drive shaft being rotated to feed the printing media; a detection means that is provided in the drive shaft and detects the rotational speed of the drive shaft; and a control means for controlling the motor, the control means controlling the motor based on an input from the detection means so that the rotational speed of the drive shaft becomes constant.

According to the present invention, there is provided a printing media feeding speed control method that rotates a drive shaft through a drive transmission mechanism transmitting a driving force of a motor to feed printing media, comprising the steps of: detecting the rotational speed of the drive shaft; and controlling the rotation number of the motor based on the detected rotational speed so that the rotational speed of the drive shaft becomes constant.

According to the present invention, there is provided a computer program used for a printing media feeding speed control method that rotates a drive shaft through a drive transmission mechanism transmitting a driving force of a motor to feed printing media, comprising the steps of: detecting the rotational speed of the drive shaft; and controlling the rotation number of the motor based on the detected rotational speed so that the rotational speed of the drive shaft becomes constant.

The present invention having the configuration as described above detects the rotational speed of the drive shaft that feeds the printing media and controls, based on the detected rotational speed, the rotation number of the motor so that the rotational speed of the drive shaft becomes constant, thereby making the feeding speed of the printing media constant. As a result, in a printed image, the density irregularity caused due to irregularity of the feeding speed of the printing media can be reduced or eliminated.

### BRIEF DESCRIPTION OF THE DRAWINGS

FIG. 1 is a view showing an image in which density irregularity has occurred;

FIG. 2 is a perspective view of a printer apparatus according to the present invention, the printer apparatus being placed flat;

FIG. 3 is a perspective view of the printer apparatus, which is placed upright;

FIG. 4 is a cross-sectional view of a print sheet;

FIG. 5 is a view showing an internal configuration of the printer apparatus;

FIG. 6 is a view showing a configuration of a printing block of the printer apparatus;

FIG. 7 is a perspective view showing the drive mechanism of a capstan;

FIG. 8 is an exploded perspective view showing a detection mechanism that detects the rotation of the capstan;

FIG. 9 is a view showing irregularity strength obtained by reading out a gray print with a scanner and applying Fast Fourier Transform to the readout density data;

FIG. 10 is a view showing a noise component appearing as a result of extracting the speed fluctuation component of the capstan at printing time and unloaded time;

FIG. 11 is a view showing a noise component appearing as a result of extracting the speed fluctuation component of the capstan in the case where images of different densities are printed;

FIG. 12 is a view showing the circuit configuration that removes a noise component included in the output from an encoder;

FIG. 13 is a view obtained by comparing noise removal effects of a filter;

FIGS. 14A and 14B are views showing correlation between the density irregularity in a printed image and speed irregularity of the capstan; FIG. 14A is a view showing spectrum strength (irregularity strength) for each frequency obtained by applying Fast Fourier Transform to the density data same as FIG. 9, and FIG. 14B is a view obtained by applying Fast Fourier Transform to clock number which is a speed fluctuation component of the capstan 14d in the feeding direction and plotting frequency on the abscissa and spectrum strength (irregularity strength) on the ordinate;

FIGS. 15A and 15B are views showing clock number based on pulse number; FIG. 15A shows the case before feedback control, and FIG. 15B shows the case after feedback control; and

FIGS. 16A and 16B are views showing irregularity strength obtained by reading out a gray print with a scanner and applying Fast Fourier Transform to the readout density data; FIG. 16A shows the case before feedback control, and FIG. 16B shows the case after feedback control.

### DETAILED DESCRIPTION OF THE PREFERRED EMBODIMENTS

A printer apparatus according to the present invention will be described below with reference to the accompanying drawings.

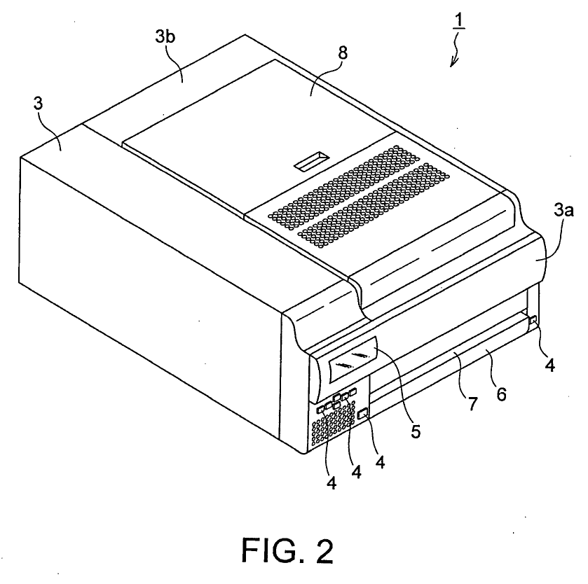

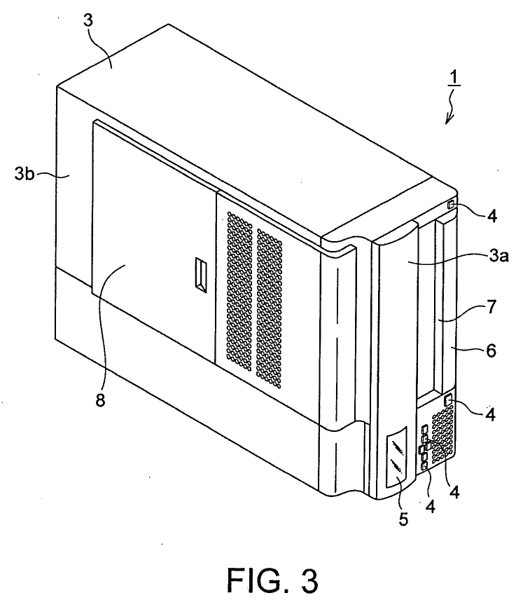

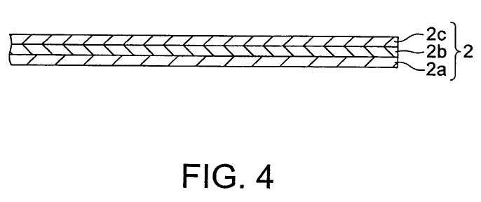

As shown in FIGS. 2 and 3, a printer apparatus 1 according to the present invention uses, as a print sheet, a print film on which CT (Computerized Tomography) image data and the like taken in a hospital is printed. The printer apparatus 1 prints the image data with thermal transfer technology. A print sheet 2 used in the printer apparatus 1 is, as shown in FIG. 4, obtained by laminating a heat-sensitive layer 2b on a resin sheet 2a and further laminating a protection layer 2c on the heat-sensitive layer 2b. The print sheet 2 thus obtained has rigidity higher than that of fine paper or coated paper and has elasticity.

As shown in FIGS. 2 and 3, the printer apparatus 1 has a rectangular casing 3. The front face 3a of the casing 3 serves as an operation face. Various operation buttons 4 such as a power button, a reset button, and a paper eject button, as well as a display section 5 constituted by an LCD (Liquid Crystal Display) that indicates an operation state and the like are arranged on the front face 3a. Further arranged on the front face 3a of the casing 3 are a detachable housing tray 6 in which the print sheets 2 are stacked and an ejection port 7 from which the print sheet 2 is ejected. The housing tray 6 and ejection port 7 are arranged adjacently to each other.

An outer lid 8 for opening/closing an opening of the casing 3 is provided on one side face 3b of the casing 3. A positioning block for positioning the print sheet 2 being fed and the like are provided in the interior of the casing 3 that is covered by the outer lid 8. When paper jam occurs, the outer lid 8 is opened to apply maintenance.

The printer apparatus 1 can be placed flat, as shown in FIG. 2, such that the sheet surface of the print sheet 2 is horizontally set, as well as, can be placed upright, as shown in FIG. 3, such that the sheet surface of the print sheet 2 is vertically set. That is, a user can select whether the printer apparatus 1 is to be placed flat or upright depending on the install location, thereby increasing usability.

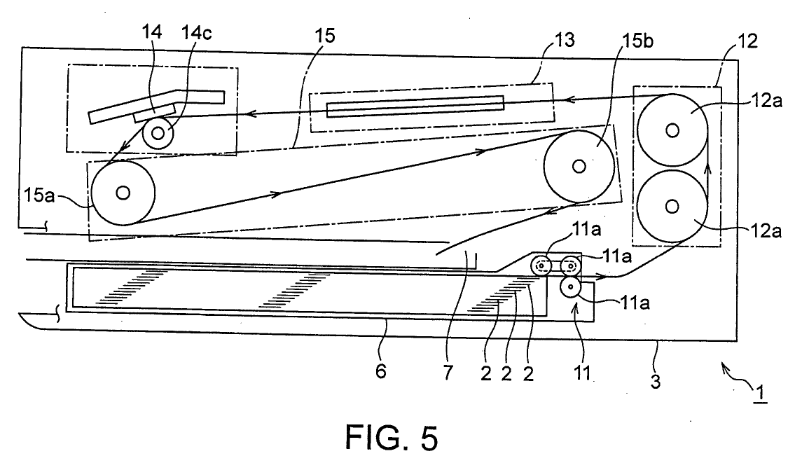

The internal configuration of the printer apparatus 1 will be described with reference to FIG. 5. The printer apparatus 1 uses a pick-up block 11 constituted by a plurality of rollers 11a and the like for picking up the stacked print sheet 2 from the housing tray 6 housed in the casing 3 to pick up one sheet and then uses a plurality of feeding rollers 12a that constitute a feeding block 12 to feed the picked up print sheet 2.

After positioning the print sheet 2 with the positioning block 13 before printing, the printer apparatus 1 perform printing on the print sheet 2 with a printing block 14 based on print data, reverses the printed print sheet 2 with a reverse roller 15a that constitutes a feeding block 15, further reverses the print sheet 2 with a reverse roller 15b that constitutes the feeding block 15, and ejects the print sheet 2 from the ejection port 7.

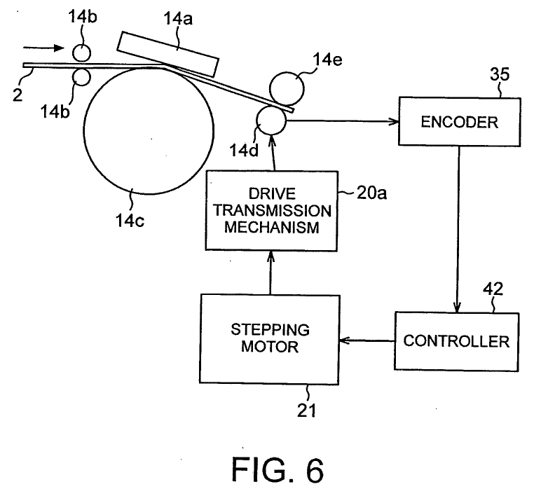

As shown in FIG. 6, in the printing block 14 used here, a print head 14a such as a thermal head for heating the print sheet 2, in which a plurality of heat elements are arranged in the direction perpendicular to the feeding direction of the print sheet 2 is supported by a head support member. A platen roller 14c is disposed opposite to the print head 14a. The print sheet 2, which is guided by guide rollers 14b and held between a capstan 14d and roller 14e, is fed by the rotation of the capstan 14d.

In the printing block 14, the print head 14a and platen roller 14c sandwich the print sheet 2, and the print head 14a heats the print sheet 2 to thereby forming an image on the print sheet 2. In this printer apparatus 1, the platen roller 14c is not in a driven state at the printing time. The platen roller is rotated in the feeding direction of the print sheet 2 when the print sheet 2 is fed without being printed.

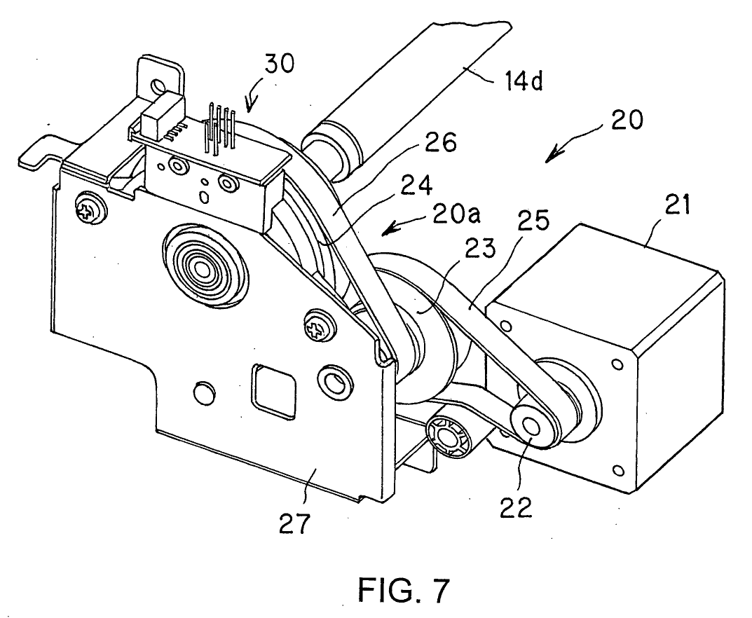

A drive mechanism 20 of the capstan 14d will be described with reference to FIG. 7. A stepping motor 21 is used as a drive source of the drive mechanism 20. A driving force of the stepping motor 21 is transmitted through a drive transmission mechanism 20a to the capstan 14d. The drive transmission mechanism 20a includes first to third pulleys 22, 23, and 24.

The first pulley 22 is fitted to the drive shaft of the stepping motor 21 and is coupled to the second pulley 23 through a first endless belt 25. The second pulley 23 is coupled to the third pulley 24 to which the capstan 14d is fitted through a second endless belt 26.

The first to third pulleys 22 to 24 are rotatably fitted to spindles provided on a base 27. When the first pulley 22 is rotated, the driving force of the stepping motor 21 is transmitted to the second pulley 23 through the first endless belt 25 and further transmitted to the third pulley 24 through the second endless belt 26, thereby causing the capstan 14d integrally fitted to the third pulley 24 to be rotated.

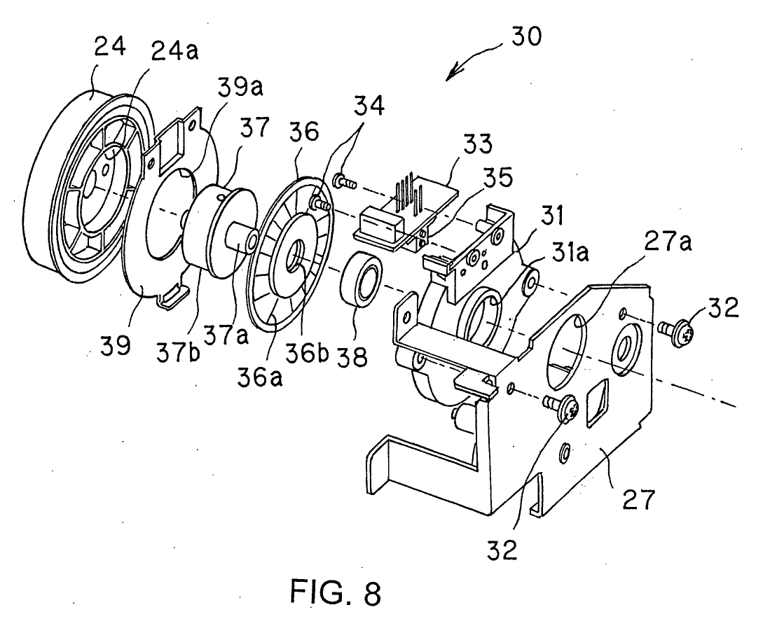

A detection mechanism 30 for detecting the rotational speed of the capstan 14d is provided in the third pulley 24 to which the capstan 14d is integrally fitted. In the detection mechanism 30, as shown in FIG. 8, a sensor substrate 33 is fixed to a bracket 31 by screws 34, and the bracket is fixed to the base 27 by screws 32.

The sensor substrate 33 has an encoder 35 constituted by a light emitter and light receiver disposed opposite to each other. An encoder disc 36 is provided between the light emitter and light receiver constituting the encoder 35. The encoder disc 36 has a plurality of slits 36a formed radially and is rotated together with the capstan 14d. In order to perform the speed control of the capstan 14d (to be described later) correctly, the number of the slits 36a is determined so that two or more pulse signals can be output from the encoder 35 while one line that constitutes an image is being printed.

The encoder 35 detects the rotation of the capstan 14d by detecting a light that has emitted from the light emitter and passed through the slits 36a with the light receiver. The encoder 35 outputs, for example, 2000 pulses during one rotation of the capstan 14d and outputs 3.6 pulses while one line is printed (for example, 6.25 ms/one line).

The detection mechanism 30 further has an attachment member 37 to which the capstan 14d is press-fitted. Provided in the center of the attachment member 37 is a sleeve 37a, to which the capstan 14d is press-fitted. The sleeve 37a is inserted through a center hole 36b of the encoder disc 36 and further inserted through a bearing 38 so that the attachment member 37 to be integrally fitted to the capstan 14d can smoothly be rotated relative to the bracket 31 fixed to the base 27.

The bearing 38 is press-fitted to a through hole 31a of the bracket 31 that has been fixed to the base 27. A cover 39 is fixed to the bracket 31 by screws or the like in such a manner to house the encoder disc 36 fixed to the attachment member 37 and bearing 38 in the space between the cover 39 and bracket 31. A main body 37b of the attachment member 37 projects from a through hole 39a of the cover 39 and is press-fitted to an inner concave-portion 24a of the third pulley 24 of the drive transmission mechanism 20a.

The capstan 14d is press-fitted to the attachment member 37 to be integrally fitted to the third pulley 24, and thereby the capstan 14d is rotated relative to the bracket 31 that has been fixed to the base 27. The encoder 35 detects the rotation of the capstan 14d by detecting a light that has passed through the slits 36a of the encoder disc 36 which is rotated integrally with the capstan 14d through the attachment member 37. The capstan 14d goes into the feeding path of the print sheet 2 through a through hole 27a of the base 27 to feed the print sheet 2 in corporation with the roller 14e.

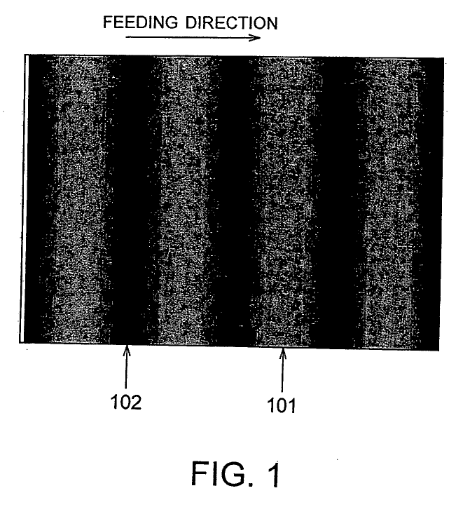

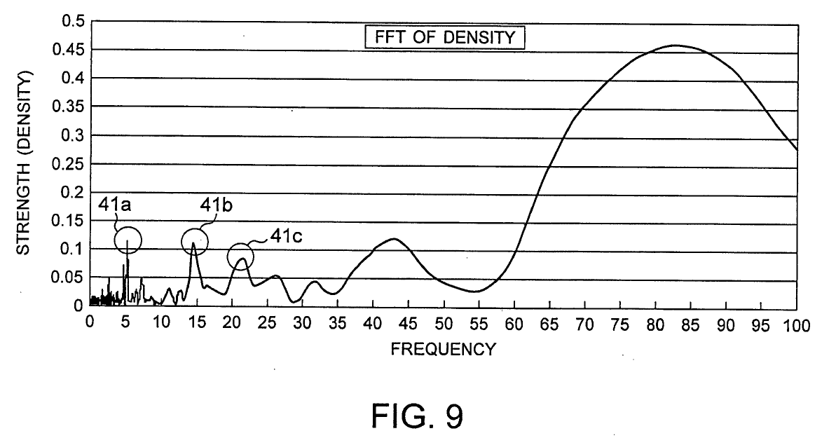

In an image printed by a conventional printer apparatus, the density irregularity occurs, as shown by the areas 101 and 102 in FIG. 1. To verify this, grey is printed on the entire surface of the print sheet 2 as shown in FIG. 1, the gray print is read out with a scanner, and the read out density data is subjected to the Fast Foirier Transform along the feeding direction of the print sheet 2. The obtained data is shown in FIG. 9.

FIG. 9 shows that the abscissa denotes frequency, and the ordinate denotes spectrum strength (irregularity strength). As can be seen from FIG. 9, peak frequency components 41a to 41c appear at a plurality of frequency levels, which appears as the density irregularity. The peak frequency component 41a corresponds to unsteady component of the rotation of the first pulley 22, the peak frequency component 41b corresponds to unsteady component of the rotation of the second pulley 23, and the peak frequency component 41c corresponds to unsteady component of the ½ rotation of the capstan 14d.

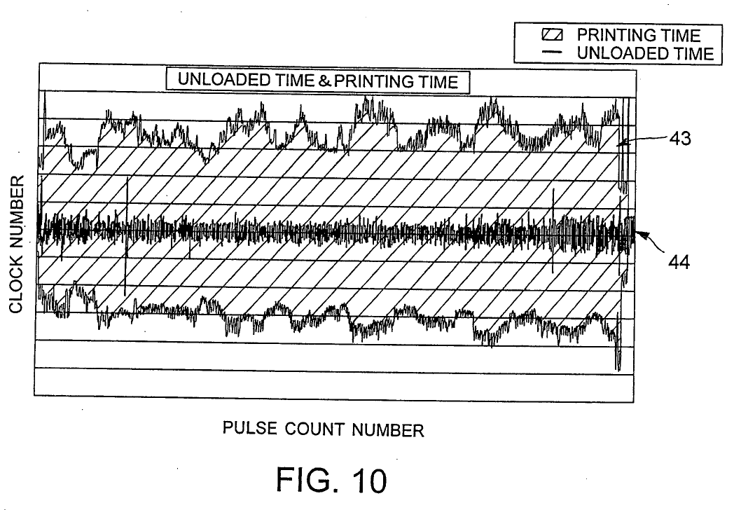

Fluctuation in the rotational speed of the capstan 14d that causes the density irregularity will be verified. Here, the encoder 35 is fitted to the capstan 14d like the configuration of the printer apparatus 1, and CPU clock number corresponding to the pulse count number of the output from the encoder 35 is measured. FIG. 10 shows the relationship between the clock number and the pulse count number at printing time where the print sheet 2 is allowed to run and at non-feeding time where the print sheet is not allowed to run, that is, unloaded time. A line 43 denotes the printing time, and a line 44 denotes the unloaded time. However, the output from the encoder 35 contains an enourmous amount of noise components. Further, the noise level greatly differs between the printing time and unloaded time.

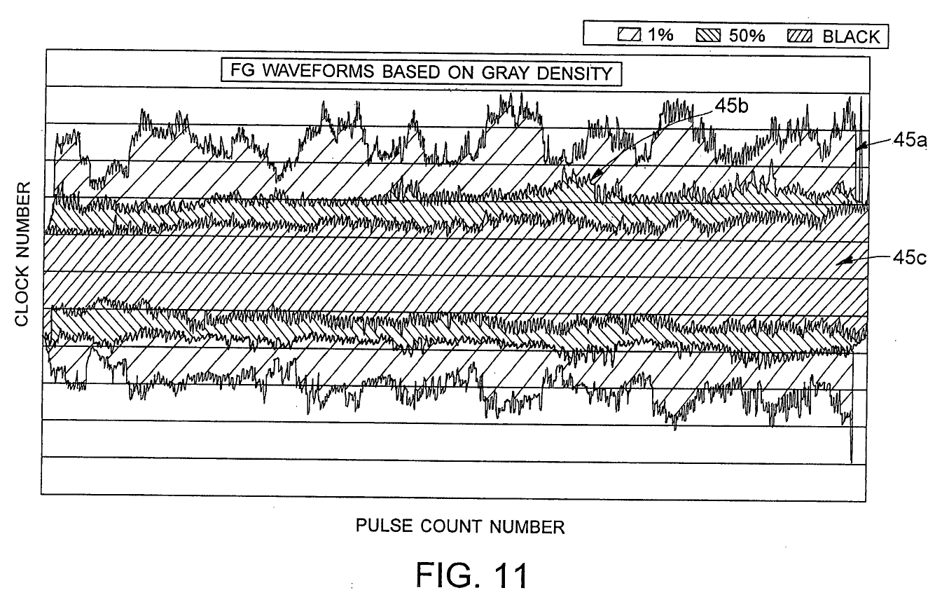

FIG. 11 shows the relationship between the clock number and the pulse count number of the output from the encoder 35 when images of different densities (black 100%, black 50%, black 1%) are printed. Aline 45a denotes black 1%, a line 45b denotes black 50%, and a line 45c denotes black 100%. However, also in FIG. 11, the output from the encoder 35 contains an enourmous amount of noise components. Further, the noise level greatly differs depending on the densities.

In the printer apparatus 1 according to the present invention, a pulse signal indicating the rotation number of the capstan 14d is input to the controller 42 from the encoder 35, as shown in FIG. 6. The controller 42 removes noise components from the data shown in FIGS. 10 and 11 and thereby extracts only a speed fluctuation component of the capstan 14d.

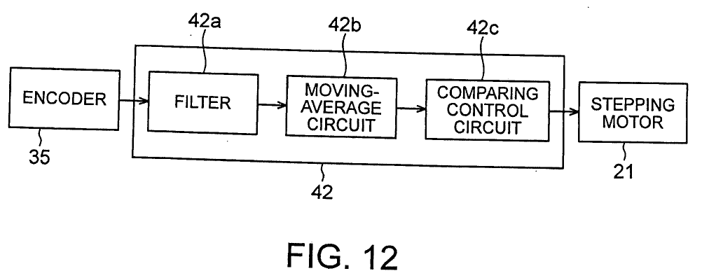

That is, the controller 42 includes, as shown in FIG. 12, a filter 42a to which the pulse signal from the encoder 35 is input, a moving-average circuit 42b which performs moving-average of a filtering result, and a comparing control circuit 42c which generates a control signal for the stepping motor 21.

The filter 42a removes the noise components from the signal as shown in FIGS. 10 and 11 and thereby extracts the speed fluctuation component of the capstan 14d. In order to make the rotational speed of the capstan 14d constant, the filter 42a is required to perform sequential real-time processing. Further, it is preferable to decrease computation amount. Consequently, a dynamic Kalman filter is used as the filter 42a. The Kalman filter can sufficiently perform computation within one cycle of the input pulse from the encoder 35.

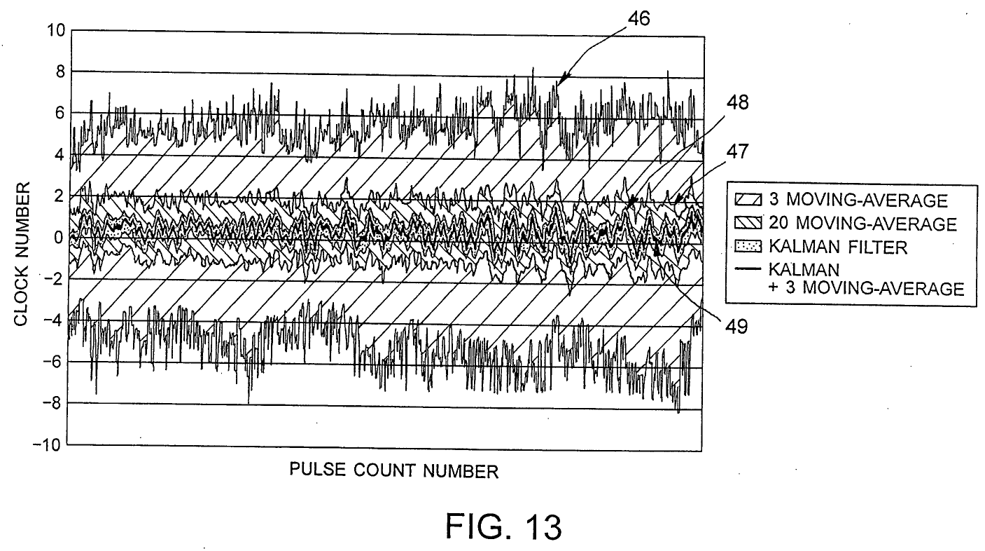

FIG. 13 shows the relationship between the CPU clock number and the pulse count number obtained by filtering the output from the encoder 35. In FIG. 13, a line 46 denotes characteristics obtained by 3 moving-average processing, a line 47 denotes characteristics obtained by 20 moving-average processing, a line 48 denotes characteristics obtained by filtering with the Kalman filter, and a line 49 denotes characteristics obtained by Kalman filtering and 3 moving-average processing. As can be seen from FIG. 13, the noise can be removed more effectively with the Kalman filtering (line 48) than with n moving average processing (lines 46 and 47).

As shown by the line 48, the Kalman filter cannot remove the noise component completely. To cope with this, as shown in FIG. 12, the moving-average circuit 42b is connected to the rear stage of the filter 42a in the controller 42 to perform moving-average processing for the output from the Kalman filter. As shown in FIG. 13, by adding the 3 moving-average processing to the Kalman filtering (line 49), it is possible to remove the noise more effectively than in the case where only Kalman filtering is applied (line 49), thereby extracting the speed fluctuation component of the capstan 14d.

The number of moving-average processing is not limited to 3. Further, the moving-average processing may be performed at the front stage of the Kalman filter.

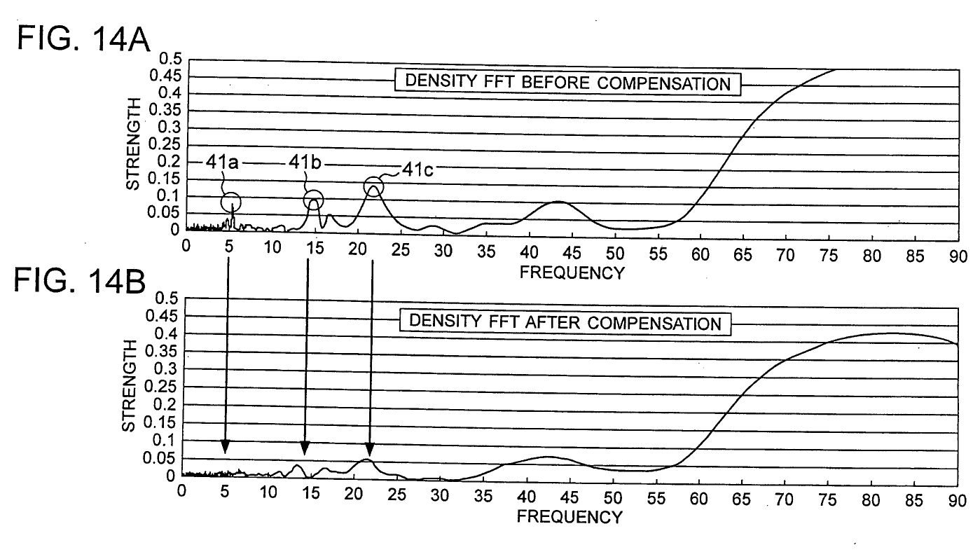

FIG. 14 is a view for comparing the density irregularity in a printed image and speed irregularity of the capstan. More specifically, FIG. 14A is a view showing the relationship between frequency (abscissa) and spectrum strength (irregularity strength) (ordinate) obtained by applying Fast Fourier Transform to the density data same as FIG. 9, and FIG. 14B is a view showing the relationship between frequency (abscissa) and spectrum strength (ordinate) obtained by applying Fast Fourier Transform to clock number which is a speed fluctuation component of the capstan 14d in the feeding direction. The comparison between FIG. 14A and FIG. 14B reveals that the peak frequency components 41a to 41c in FIG. 14A and peak frequency components 40a to 40c in FIG. 14B appear at the same frequency levels. This indicates that there exists a correlation between the density irregularity and rotational speed of the capstan 14d.

The controller 42 determines the peak frequencies 40a to 40c shown in FIG. 14B as a factor of the density irregularity in a printed image and controls the stepping motor 21 with the comparing control circuit 42c so that the peak frequencies 40a to 40c is reduced or eliminated. The comparing control circuit 42c compares a signal output from the moving-average circuit 42b and a reference signal stored in a memory.

To be more specific, when the signal (line 49 in FIG. 13) that has been subjected to the filter processing in the filter 42a and moving-average circuit 42b is greater than the reference signal, that is, when the speed of the capstan 14d is less than a reference speed, the comparing control circuit 42c makes the cycle of the pulse signal that drives the stepping motor 21 shorter than a reference pulse signal to increase the rotation number of the stepping motor 21, thereby increasing the rotational speed of the capstan 14d.

When the signal (line 49 in FIG. 13) that has been subjected to the filter processing in the filter 42a and moving-average circuit 42b is smaller than the reference signal, that is, when the speed of the capstan 14d is greater than a reference speed, the comparing control circuit 42c makes the cycle of the pulse signal that drives the stepping motor 21 longer than a reference pulse signal to reduce the rotation number of the stepping motor 21, thereby reducing the rotational speed of the capstan 14d.

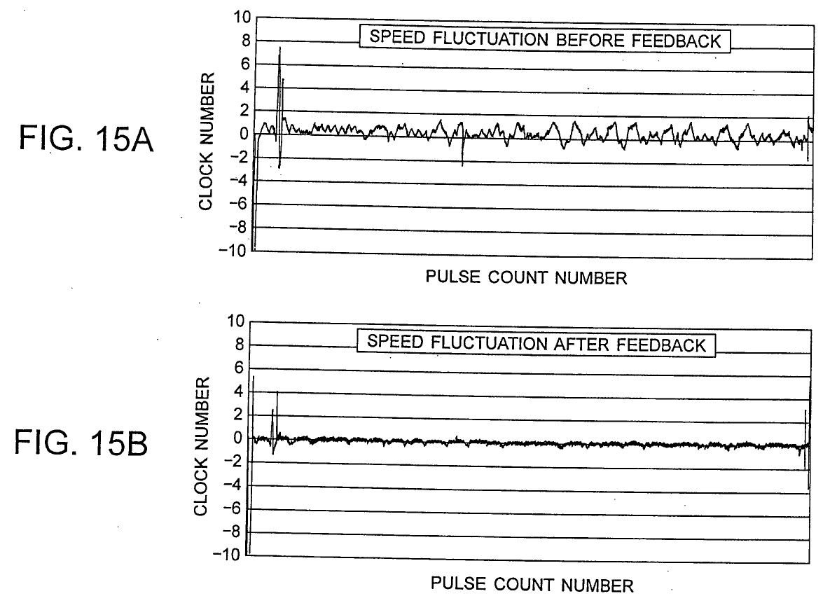

FIG. 15 shows a result obtained when the controller 42 performs the above control. In FIG. 15, FIG. 15A shows a result obtained before feedback control of the controller 42, and FIG. 15B shows a result obtained after feedback control of the controller 42. As can be seen from the comparison between FIGS. 15A and 15B, the fluctuation of the CPU clock becomes smaller in FIG. 15B (after feedback control) than in FIG. 15A, that is, the fluctuation of the CPU clock is substantially eliminated to make the rotational speed of the capstan 14d nearly constant.

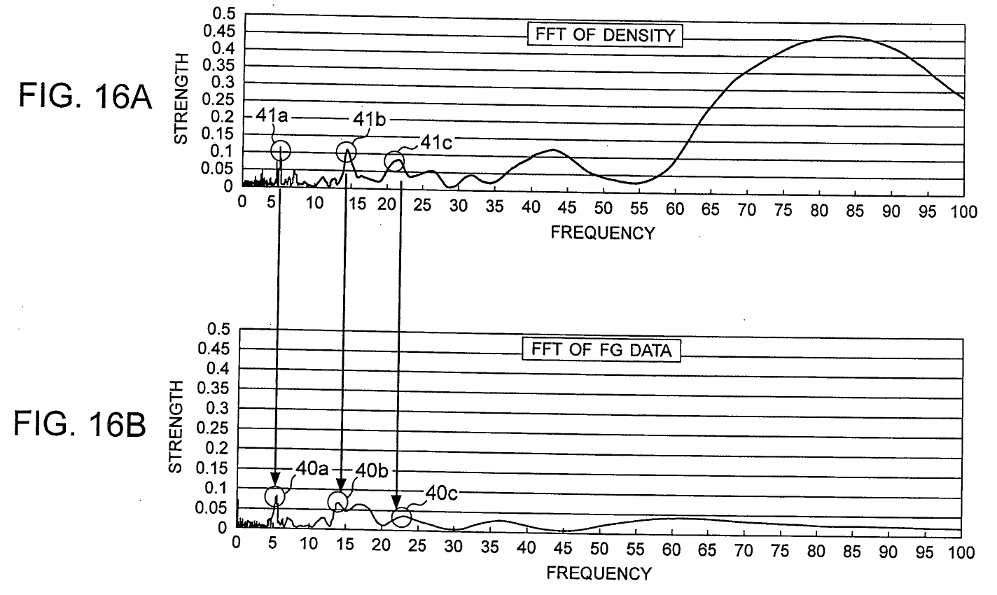

As in the case of FIG. 9, grey is printed on the entire surface of the print sheet 2, the gray print is read out with a scanner, and the read out density data is subjected to the Fast Fourier Transform (FFT) along the feeding direction of the print sheet 2. The obtained density data is shown in FIG. 16. In FIG. 16, FIG. 16A shows a result obtained before feedback control, and FIG. 16B shows a result obtained after feedback control. As can be seen from the comparison between FIGS. 16A and 16B, the entire curve including the peak frequency components 41a to 41c becomes flat. This indicates the density irregularity has been reduced in a printed image.

In the printer apparatus 1 having the configuration as described above, the controller 42 extracts the rotational speed fluctuation component of the capstan 14d and controls the stepping motor 21 so that the speed fluctuation component is reduced or eliminated, thereby making the rotational speed of the capstan 14d constant while allowing for a mechanical error of the drive transmission mechanism 20a and the like. Therefore, in a printed image, the density irregularity caused due to the fluctuation of the feeding speed of the print sheet 2 can be reduced or eliminated. Further, it is possible to make it easier to design and assemble the drive transmission mechanism 20a.

In the encoder disc 36 provided for the capstan 14d, the encoder 35 can output a plurality of pulses while the print head 14a prints one line. Further, the Kalman filter is used as the filter 42a, so that the controller 42 can extract the fluctuation component of the rotational speed of the capstan 14d in real time. Therefore, the controller 42 has excellent response characteristics to the speed fluctuation and thereby can control the rotational speed of the capstan 14d in real time.

The above control performed by the controller 42 can be realized by hardware as well as by software. In the case where software is used, the above control can be realized by storing software to which the present invention is applied in a memory such as a hard disc or semiconductor memory and by performing computation with a CPU.

The print sheet 2 is fed by the capstan 14d in the printer apparatus 1 described above. In the case of using a printer apparatus in which the platen roller 14c is rotated in printing time to feed the print sheet 2, the encoder 35 may be fitted to the drive shaft of the platen roller 14c. In this configuration, the controller 42 extracts the rotational speed fluctuation component of the platen roller 14c to thereby control the stepping motor 21 so that the platen roller 14c is rotated at a constant speed. By this, it is possible to obtain the same effect as that in the case of the printer apparatus 1.

Although the heat-sensitive layer 2b is formed on the print sheet 2 and the print head 14a prints an image on the heat-sensitive layer 2b in the above example, the present invention is also applied to a thermal printer apparatus in which a print head allows ink of an ink ribbon to sublime to thereby thermally transfer an image on a print sheet, or an inkjet printer that discharges ink to print an image on a print sheet.

It should be understood by those skilled in the art that various modifications, combinations, sub-combinations and alternations may occur depending on design requirements and other factors insofar as they are within the scope of the appended claims or the equivalents thereof.

What is claimed is:

1. A printing media feeding apparatus comprising:
feeding means that includes a motor, a drive transmission mechanism which transmits a driving force of the motor, and a drive shaft to which the driving force is transmitted by the drive transmission mechanism, the drive shaft being rotated to feed the printing media;
detection means that is provided in the drive shaft and detects the rotational speed of the drive shaft; and
control means for controlling the motor,
the control means controlling the motor based on an input from the detection means so that the rotational speed of the drive shaft becomes constant.

2. The printing media feeding apparatus according to claim 1, wherein the control means includes a filter that extracts a rotational speed fluctuation component of the drive shaft.

3. The printing media feeding apparatus according to claim 2, wherein the filter is a Kalman filter.

4. The printing media feeding apparatus according to claim 3, wherein the control means further includes a moving-average circuit.

5. The printing media feeding apparatus according to claim 1, wherein the motor is a stepping motor.

6. The printing media feeding apparatus according to claim 1, wherein the drive shaft is a capstan.

7. A printing apparatus comprising:
a print head that prints visual data on printing media;
feeding means that includes a motor, a drive transmission mechanism which transmits a driving force of the motor, and a drive shaft to which the driving force is transmitted by the drive transmission mechanism, the drive shaft being rotated to feed the printing media;
detection means that is provided in the drive shaft and detects the rotational speed of the drive shaft; and
control means for controlling the motor,
the control means controlling the motor based on an input from the detection means so that the rotational speed of the drive shaft becomes constant.

8. A printing media feeding speed control method that rotates a drive shaft through a drive transmission mechanism transmitting a driving force of a motor to feed printing media, comprising the steps of:
detecting the rotational speed of the drive shaft; and
controlling the rotation number of the motor based on the detected rotational speed so that the rotational speed of the drive shaft becomes constant.

9. The printing media feeding speed control method according to claim 8, wherein the step of controlling the motor includes a step of extracting a rotational speed fluctuation component of the drive shaft.

10. The printing media feeding speed control method according to claim 9, wherein the rotational speed fluctuation component of the drive shaft is extracted by a Kalman filter circuit.

11. The printing media feeding speed control method according to claim 10, further comprising a step of performing moving-average processing.

12. A computer program used for a printing media feeding speed control method that rotates a drive shaft through a drive transmission mechanism transmitting a driving force of a motor to feed printing paper, comprising the steps of:
detecting the rotational speed of the drive shaft, and
controlling the rotation number of the motor based on the detected rotational speed so that the rotational speed of the drive shaft becomes constant.

13. A printing media feeding apparatus comprising:
a feeding section that includes a motor, a drive transmission mechanism which transmits a driving force of the motor, and a drive shaft to which the driving force is transmitted by the drive transmission mechanism, the drive shaft being rotated to feed the printing media;
a detection section that is provided in the drive shaft and detects the rotational speed of the drive shaft; and
a controller that controls the motor,
the controller controlling the motor based on an input from the detection section so that the rotational speed of the drive shaft becomes constant.

14. A printing apparatus comprising:
a print head that prints visual data on printing media;
a feeding section that includes a motor, a drive transmission mechanism which transmits a driving force of the motor, and a drive shaft to which the driving force is transmitted by the drive transmission mechanism, the drive shaft being rotated to feed the printing media;
a detection section that is provided in the drive shaft and detects the rotational speed of the drive shaft, and
a controller that controls the motor,
the controller controlling the motor based on an input from the detection section so that the rotational speed of the drive shaft becomes constant.
